(19) United States
(12) Patent Application Publication
(10) Pub. No.: US 2008/0233539 A1
(43) Pub. Date: Sep. 25, 2008

(54) Abutment For a Tooth Implant

(76) Inventors: Hans-Dieter Rossler, Kleinostheim (DE); Fabian Peters, Mannheim (DE)

Correspondence Address: OSTROLENK FABER GERB & SOFFEN, 1180 AVENUE OF THE AMERICAS, NEW YORK, NY, 100368403, US

(21) Appl. No.: 12/064,555

(22) PCT Filed: Aug. 17, 2006
(86) PCT No.: PCT/CH2006/000438

§ 371 Date: Mar. 12, 2008

(30) Foreign Application Priority Data
Aug. 22, 2005 (EP) 05 405 488.7

(51) Int. Cl. A61C 8/00

(52) U.S. Cl. 433/174

(57) ABSTRACT

The abutment for a tooth implant comprises a connecting portion for fixing to the tooth implant and a post with a groove. In one example, the connecting portion and the post are made in one-piece and the abutment has the form of a sleeve. Such an abutment permits repeated further treatment and use of snap-on elements, in particular, the use of a snap-on cap which can be used as a manipulation element or as a base for the production of a crown.

The present invention relates to an abutment for a tooth implant and to a device for handling the abutment and for further processing.

An abutment for a tooth implant is known from U.S. Pat. No. 5,549,475. The abutment disclosed therein consists of an insert which is screwed into the implant and to which a cylindrical post with a cap integrally arranged thereon is fastened.

US 2003/0082498 A1 discloses a component for improving impression-taking in the case of an implant with an abutment, wherein the limit stop of the implant has an engaging feature for fastening of the abutment, and a shoulder is further present.

U.S. Pat. No. 6,315,562 B1 discloses an abutment carrier which is fastened to a post screwed to the implant. The post has a groove which is engaged by fingers of the carrier.

Proceeding from that prior art, it is a first object of the present invention to create an abutment for a tooth implant, which abutment is of a relatively simple construction and simplifies the subsequent operations. That object is attained with an abutment according to patent claim 1.

It is a further object of the invention to provide a device for handling the abutment, which may also be used for further processing steps and applications. That object is attained with the device according to patent claim 11.

Further advantages, such as, for example, measures promoting adhesion of the connective tissue, are defined in the dependent claims.

The invention will be described in detail hereinafter with reference to drawings of illustrative embodiments.

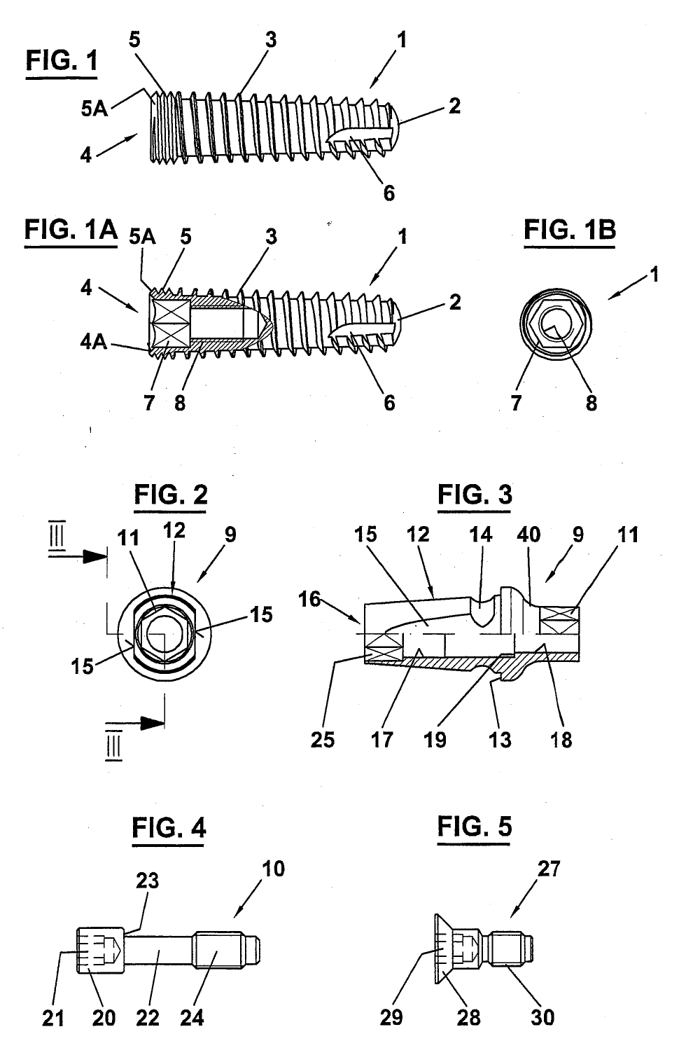

FIG. 1 shows a tooth implant in plan view,

FIG. 1A is a view from the left of FIG. 1,

FIG. 1B shows a partial section of FIG. 1,

FIG. 2 shows an abutment according to the invention for the tooth implant of FIG. 1, viewed from the front,

FIG. 3 shows the abutment in accordance with the section III-III in FIG. 2,

FIG. 4 shows a retaining screw,

FIG. 5 shows a closure screw,

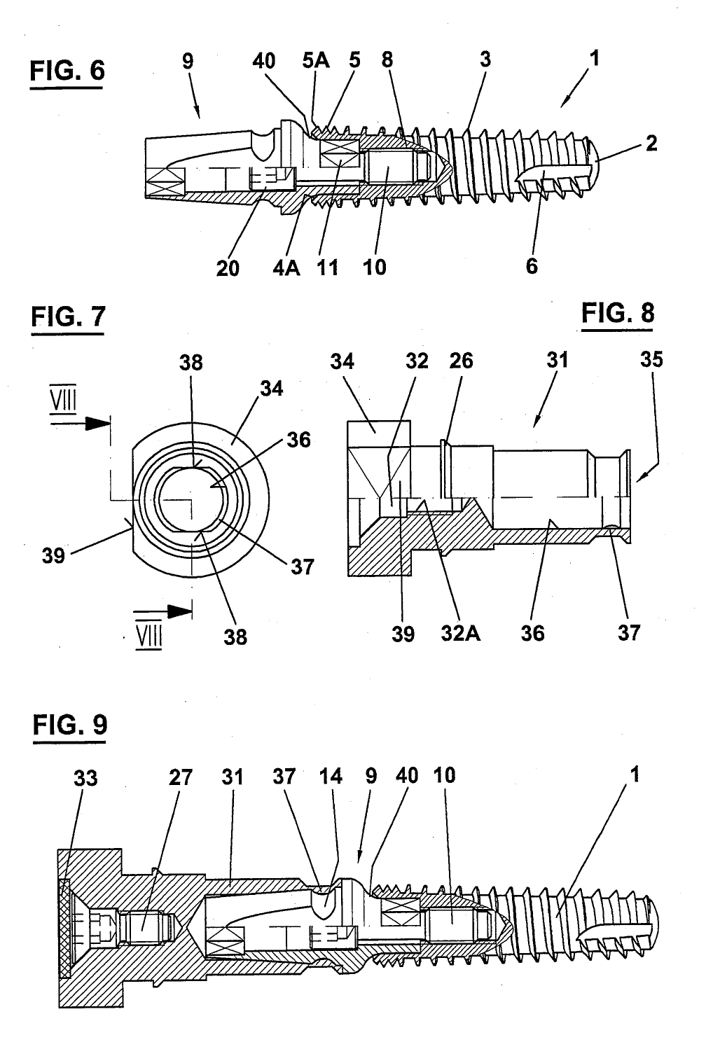

FIG. 6 shows an abutment screwed to the tooth implant,

FIG. 7 shows a snap-on cap according to the invention, viewed from the front,

FIG. 8 shows the snap-on cap in accordance with the line VIII-VIII in FIG. 7,

FIG. 9 shows a tooth implant ready for despatch, assembled with an abutment and having a snap-on cap.

FIGS. 1, 1A and 1B show, for example, a tooth implant 1, preferably made of pure titanium, having the rounded apical end 2, the progressive multiple thread 3, in this illustrative embodiment a two-start, self-tapping thread, which becomes wider from the apical end to the other, cervical end 4 and which is adjoined by a micro-thread 5, similarly a multiple thread, for example a three-start thread.

The micro-thread 5 is adjoined towards the cervical end 4 by a tapered portion 5A and the implant has an inwardly oriented chamfer 4A. Both measures make better bone adhesion possible and thus prevent bone resorption and promote growth of connective tissue at the cervical end of the implant. When an abutment having an outwardly curved shoulder is used, the effective biological width is increased with the tapered portion and the chamfer.

The rounded apical end largely prevents injury to anatomical structures such as the floor of the sinus, the floor of the nose, the mandibular nerve or the mucosa when the tooth implant is being screwed in.

The tooth implant 1 further has a conical shape which tapers towards the apical end 2, which increases the primary stability in comparison with a cylindrical tooth implant shape when being screwed into a straight cavity, and results in perfect adaptation in the cervical region.

The progressive multiple thread considerably improves the primary stability. A high mechanical primary stability is the most important prerequisite for immediate and early loading of the tooth implant. By virtue of the progressive thread, micro-movements of the inserted tooth implant are largely prevented and, as a result, incorporation of the implant and osseointegration are promoted.

In the cervical region, the progressive thread becomes a multiple micro-thread in order to avoid excessively high compression and necrosis in the corticalis. The tooth implant further has in the apical region cutting channels 6, for example two, which also serve as relief channels for the bone chips.

It will be apparent from FIGS. 1A and 1B that the tooth implant has at the cervical end a hexagon socket 7 adjoined by a bore 8 with thread.

FIGS. 2 and 3 show an illustrative embodiment of an abutment 9 according to the invention which may be fastened to the tooth implant by means of a retaining screw 10, see FIG. 4. The abutment is preferably also made of pure titanium and has a connecting portion 11 constructed as a hexagonal element which fits into the hexagon socket 7 of the tooth implant. That hexagonal element 11 is adjoined by a multifunctional post 12 which, starting at the connecting portion, has a platform 13 and tapers from there towards the end. Close to the platform 13, there is a circumferentially extending groove 14, and two opposing flat portions 15 are disposed longitudinally of the post.

The groove in the cervical region of the post makes it possible to use a snap-on technique for various parts, which is simple to manage, very precise and time-saving. That applies especially to the transfer, to the fastening of the temporary crown or to impression-taking with a multifunctional snap-on cap, see FIGS. 7 to 9. In addition, the groove serves to enable optimum distribution of the fastening cement when the final restoration is being inserted.

As is apparent from FIG. 2, the abutment is constructed as a sleeve and has a continuous bore with two different diameters. Viewed from the cervical end 16, the diameter of the bore 17 is greater than that of the adjoining bore 18, thereby forming a shoulder 19 on which the head of the retaining screw is supported. Disposed at the cervical end there is a hexagon socket 25 by means of which the implant together with the abutment is screwed into the bone by a hexagon screwdriver.

The retaining screw 10 serves to fasten the abutment to the tooth implant and is constructed accordingly. In FIG. 4, described from left to right, the retaining screw comprises a head 20 with a hexagon socket 21, a cylindrical portion 22 and a shoulder 23 therebetween and, adjoining the cylindrical portion, a thread 24 corresponding to the bore with thread 8 in the tooth implant.

From FIG. 6, a combination of the tooth implant with the abutment, it will be apparent that the retaining screw 10 extends through the abutment and can be screwed into the tooth implant with a hexagon screwdriver. The shoulder 23 of the retaining screw 10 is supported during that operation on the shoulder 19 of the abutment, with the result that as the retaining screw is screwed in, the abutment and the tooth implant are pulled together and secured.

As will be apparent from the combination shown in FIG. 6, the abutment post 12 has a smaller diameter than that of the tooth implant in order to assist the attachment of soft and hard tissue and, in the long term, prevent bone resorption and risk of infection. The multifunctional post 12 is to be used as standard for all tooth implants of this system, even in the case of different diameters, and serves
a) as a transfer post from the double sterile packaging into the predrilled cavity,
b) for screwing into the predrilled cavity,
c) as a temporary post and
d) as the final post.

The two flat portions 15 of the post serve on the one hand to cement the crown in a manner securing it against rotation and to obtain correct axial alignment. This makes precise transfer possible.

The posts are preferably coded, for example by giving them a bicolour marking, to avoid confusion. The flat surfaces may in that case be left untreated or uncoloured.

To obtain a stable press-fit between abutment and tooth implant, the hexagonal element 11 and the hexagon socket 7 of the tooth implant have a conicity of from 0.5° to 7°. This also makes exact transfer possible, since it is not possible for wobbling to occur, as is unavoidable in the case of straight surfaces owing to the necessary tolerance.

The biological width, the connective tissue covering at the cervical implant end, is according to Tarnow and other authors from 1.5 to 3.5 mm. The previously prepared shoulder 40 on the fastening portion of the abutment of approximately from 1.7 to 2.1 mm, preferably 1.9 mm, above the end of the tooth implant takes that biological width of the soft tissue into account, which provides considerable advantages for long-term success from an aesthetic and a functional point of view. That effect is assisted by the tapered portion 5A and the chamfer 4A at the cervical end of the implant.

The described abutment having the post with a circumferentially extending groove for a snap-on technique is advantageous not only in respect of the implant described as an example in the introduction but also in respect of all other types of implant, in which case, however, the connecting portion of the abutment has to be of an appropriate form and may have, instead of a hexagonal element, other coupling and connecting means.

If the tooth implant is to grow in first, without the abutment, it is essential to seal its opening 7 and 8. There is used for that purpose the closure screw 27 of FIG. 5, which has a countersunk head 28 with a hexagon socket 29 and a thread 30 that fits into the thread 8 of the tooth implant.

In the packaging ready for despatch shown in FIG. 9, that closure screw is screwed into a corresponding recess 32 at the rear portion of a snap-on cap 31 and is secured by means of a cover 33.

The multifunctional snap-on cap 31 is made from a burn-out plastics material and, as its name reveals, it is able to perform various functions:
a) it may serve as an introduction aid for transfer from the sterile packaging into the predrilled cavity and for screwing-in of one to two turns.
b) it may serve as a base for the temporary crown which can be fitted exactly. Fastening of the crown is effected by means of the described snap-on technique and temporary cement.
c) it may serve as an impression cap in conjunction with prefabricated laboratory tooth implants to obtain exact transfer. The shape of the snap-on cap is matched to the post of the abutment.
d) it may serve as a pre-modelled crown base for the dental technician and as a base for the final restoration after the technician has milled away the receiving ring 34.

The snap-on cap altogether makes possible an economical workflow in the collaboration between dentist and dental technician, saving time and affording high precision.

The snap-on cap has at its apical end 35 a bore 36 with a neck 37 which corresponds to the groove 14 of the abutment post. Accordingly, the snap-on cap may be snapped onto the abutment post in order to be securely fixed there. In addition, at its periphery it has a bead 26.

So that the snap-on cap may be used as a screwing-in aid it must be held in a manner securing it against rotation relative to the abutment post. That is achieved by means of the snap-on cap having in the inner bore 36 two opposing flat surfaces 38 which cooperate with the two flat portions 15 of the abutment post.

The closure screw 27 is inserted in a receiving ring 34 of the cap, which ring has a flat portion 39 which serves to secure a crown.

As will be apparent from the description and the drawings, the abutment of the snap-on cap with all its advantages is largely independent of the connection of the abutment to the implant.

1. An abutment for a tooth implant, wherein the abutment has a connecting portion for fastening to the tooth implant and has a post with a groove.

2. The abutment according to claim 1, wherein the connecting portion and the post are made in one piece and the abutment being constructed as a sleeve.

3. The abutment according to claim 2, wherein the connecting portion is constructed as a hexagonal element.

4. The abutment according to claim 1, wherein the portion of the abutment adjoining the hexagonal element is outwardly curved and dimensioned to produce a biological width of approximately 2 mm.

5. The abutment according to claim 1, wherein the post two flat portions.

6. The abutment according to claim 5, further comprising the post having at its cervical end a hexagon socket.

7. The abutment according to claim 6, wherein the tooth implant has a hexagon socket which, like the hexagonal element of the abutment, has a conicity of from 0.5° to 7°.

8. The abutment according to claim 7, comprising a conical screw portion in the tooth implant having a thread which becomes progressively wider from the rounded apical end, the progressive multiple thread being adjoined by a multiple micro-thread having a smaller pitch.

9. The abutment according to claim 8, wherein the post has a smaller diameter than that of the tooth implant.

10. The abutment according to claim 8 wherein the tooth implant has a bore with a thread and the abutment may be fastened to the implant by means of a retaining screw having an appropriate thread and extending through the abutment.

11. A device for handling an abutment according to claim 1, wherein the device is a multifunctional snap-on cap which may be snapped into the groove in the post of the abutment.

12. A snap-on cap according to claim 11, further comprising at its apical end a bore having an internal bead corresponding to the groove in the post, and internal surfaces corresponding to the flat portions on the post.

13. The snap-on cap according to claim 12, wherein at the cervical end, it contains a closable bore for receiving a closure screw for the implant.
